(19) United States
(12) Patent Application Publication
(10) Pub. No.: US 2011/0163988 A1
(43) Pub. Date: Jul. 7, 2011

(54) IMAGE OBJECT CONTROL SYSTEM, IMAGE OBJECT CONTROL METHOD AND IMAGE OBJECT CONTROL PROGRAM

(75) Inventor: Shuji Senda, Tokyo (JP)

(73) Assignee: NEC CORPORATION, Minato-ku, Tokyo (JP)

(21) Appl. No.: 13/063,690

(22) PCT Filed: Jul. 7, 2009
(86) PCT No.: PCT/JP2009/003139

§ 371 Date: Mar. 11, 2011

(30) Foreign Application Priority Data
Sep. 22, 2008 (JP) 2008-242995

(51) Int. Cl. G06F 3/041

(52) U.S. Cl. 345/173

(57) ABSTRACT

An inside/outside determining unit determines whether a touch position of a contact body is located outside or inside an inside/outside determining target region defined with respect to a display position of an image object as a target region for inside/outside determination of the touch position of the contact body. The signal generating unit generates a signal indicating the operation performed with respect to the image object when it is determined that the touch position of the contact body is located outside the inside/outside determining target region.

### TECHNICAL FIELD

The present invention relates to an image object control system, an image object control method and an image object control program that control a displayed image object when the user performs an operation on a touch sensor with a pen or a finger.

### BACKGROUND ART

By using a pointing device capable of directly pointing a position on a display screen with a pen (stylus) or a finger, it is possible to easily operate GUI (Graphical User Interface) displayed on a display panel through intuition. For example, a button can be pressed by touching a displayed GUI part with the pen or the finger, or a slider value can be changed by dragging a slider displayed as the GUI part.

Patent document 1 describes a cursor-position touch-control method of moving a cursor position with a pointer such as the finger. According to the cursor-position touch-control method described in Patent document 1, when the pointer such as the finger touches a screen, it is determined whether or not a contact point on the display screen matches a cursor. Then, when the cursor matches the contact point and the pointer is moved while being in contact with the screen, the cursor position is updated to the position corresponding to the contact point of the pointer. According to the method described in Patent document 1, the operation of moving the cursor can be performed through intuition.

A device called as a touch pad for achieving the same operation as that of a mouse with the finger is known. Notebook personal computers are often provided with the touch pad. By sliding the finger on the touch pad provided separately from the display panel, the cursor can be moved according to a sliding distance, so that movement similar to relative movement with the mouse can be achieved.
[Patent document 1] Unexamined Patent Publication No. 7-191807 (paragraphs [0006] to [0012])

However, as compared to the operation of providing the movement of the cursor by the relative movement with the mouse or the like, the operation of designating a position on the display panel with the finger as in the method described in Patent document 1 is more difficult for the user to accurately designate a desired position. Reasons for this are as follows.

For example, a device such as a touch panel capable of designating a position with the pen or the finger is configured so that a touch sensor is provided on a display panel such as a liquid crystal display panel so as to unify them. Accordingly, the image object such as the cursor is displayed on the display panel, while the pen or the finger is contact with the touch sensor above the display panel. Thus, due to parallax between the surface of the display panel and the surface of the touch sensor, it is difficult for the user to accurately designate the desired position. Although a difference between the position designated by the user and the position touched with the pen or the like can be reduced by previously performing a correcting operation called as calibration, the difference cannot be completely eliminated due to the above-mentioned parallax and instability of the touch sensor.

Further, especially when the user performs the operation with his/her finger, the thickness of the finger enlarges a contact area. As a result, the position to be designated becomes unclear, making accurate positional designation and determination difficult.

Furthermore, in the case of performing the operation with the pen or the finger, the pen or the finger obstructs the user from viewing the image object displayed on the display panel, thereby disturbing the operation.

As described above, it is difficult for the user to accurately designate the designed position with the pen or the finger. For this reason, for example, when attempting to changing size of a window by pointing a window's corner displayed on the display panel and dragging the pointed corner, the user has difficulty in pointing the corner with the finger or the pen. Although the operation of pointing the window's corner is used as an example herein, it is difficult to accurately point a desired position also in other operations.

In addition, in situations requiring an accurate operation, the operation is facilitated by use of the pen in place of the finger. However, also in this case, a difference caused by parallax occurs.

In order to prevent such problems, it is need to display the GUI part largely so that the user can easily touch the desired position. However, in the case where a display area is limited, it is difficult to display the GUI part largely.

### SUMMARY OF THE INVENTION

Therefore, an object of the present invention is to provide an image object control system, an image object control method and an image object control program that can accurately operate the image object with a contact body such as the pen and the finger.

An image object control system according to the present invention includes an inside/outside determining unit for determining whether a touch position of a contact body is located outside or inside an inside/outside determining target region, the inside/outside determining target region being defined with respect to a display position of an image object as a target region for inside/outside determination of the touch position of the contact body, and a signal generating unit for generating a signal indicating an operation performed with respect to the image object when it is determined that the touch position of the contact body is located outside the inside/outside determining target region.

An image object control method according to the present invention includes steps of determining whether a touch position of a contact body is located outside or inside an inside/outside determining target region, the inside/outside determining target region being defined with respect to a display position of an image object as a target region for inside/outside determination of the touch position of the contact body, and generating a signal indicating an operation performed with respect to the image object when it is determined that the touch position of the contact body is located outside the inside/outside determining target region.

An image object control program according to the present invention, under which a computer executes inside/outside determining processing of determining whether a touch position of a contact body is located outside or inside an inside/outside determining target region, the inside/outside determining target region being defined with respect to a display position of an image object as a target region for inside/outside determination of the touch position of the contact body, and signal generating processing of generating a signal indicating an operation performed with respect to the image object when it is determined that the touch position of the contact body is located outside the inside/outside determining target region.

According to the present invention, the image object can be accurately operated with the contact body such as the pen and the finger.

### BRIEF DESCRIPTION OF DRAWINGS

FIG. 1 is a block diagram showing an example of configuration of an image object control system according to the present invention;

FIG. 2 is a diagram illustrating shift of a processing state of the image object control system;

FIG. 3 is a flowchart showing an example of processing progress in this exemplary embodiment;

FIG. 4 is a flowchart showing an example of relative move/absolute move determining processing;

FIG. 5 is a flowchart showing an example of click/drag determining processing;

FIG. 6 is a diagram illustrating an example of relative move;

FIG. 7 is a diagram illustrating an example of absolute move;

FIG. 8 is a diagram illustrating an example of drag of a cursor;

FIG. 9 is a flowchart showing an example of click/drag determination in the case where two types of click is used;

FIG. 10 is a diagram illustrating an example of a displayed enlarged image of a region surrounded by an outer edge of a cursor;

FIG. 11 is a diagram illustrating an example of a case where the outer edge of the cursor and an outer edge of an inside/outside determining target region do not match each other;

FIG. 12 is a diagram illustrating an example of a case where a figure that is not surrounded by an outer edge is used as the cursor;

FIG. 13 is a diagram illustrating an example of configuration of an image object control system provided with a server and a terminal;

FIG. 14 is a diagram illustrating an example of images displayed on the side of the server and the side of a thin client; and

FIG. 15 is a block diagram showing summary of the present invention.

### EXEMPLARY EMBODIMENT

Exemplary embodiments of the present invention will be described below with reference to figures. In the following, an image object control system that displays a cursor as an image object and accurately operates the cursor with a contact body is described as an example. Further, in the following, although a pen or a finger is adopted as an example of the contact body used in operation, any contact body other than the pen and the finger may be adopted.

### First Exemplary Embodiment

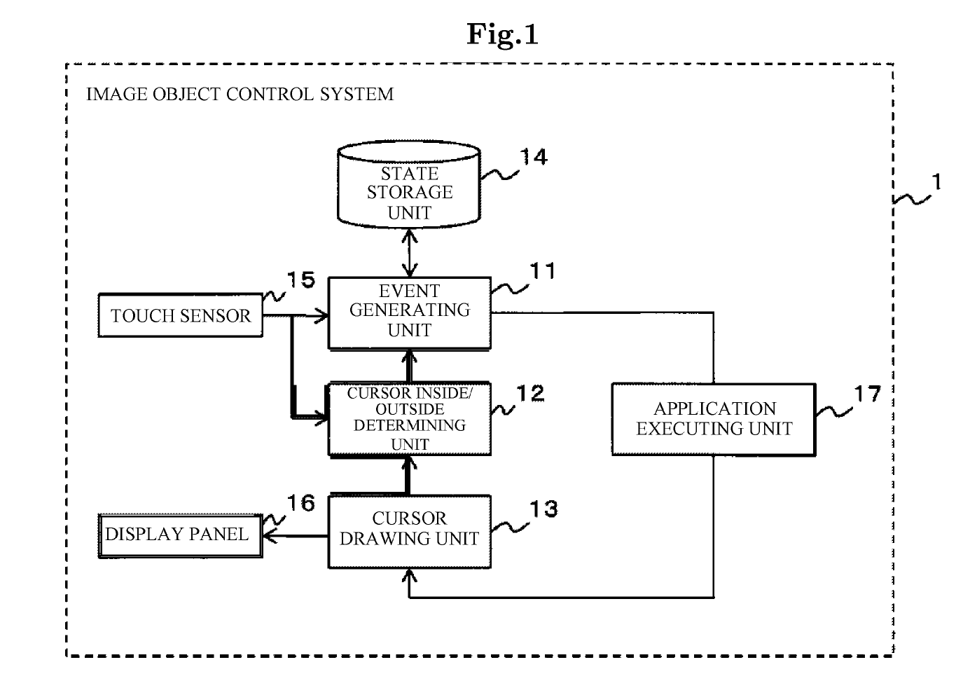

FIG. 1 is a block diagram showing an example of configuration of an image object control system in accordance with First exemplary embodiment of the present invention. The image object control system 1 of the present invention includes an event generating unit 11, a cursor inside/outside determining unit 12, a cursor drawing unit 13, a state storage unit 14, a touch sensor 15 and a display panel 16.

The image object control system 1 is further provided with an application executing unit 17 for performing processing according to an application program (hereinafter referred to as merely application). Processing contents of the application are not specifically limited.

The display panel 16 is a display device that displays an image, a cursor and the like to be displayed according to execution of the application.

A touch sensor 15 is a device that is disposed on an upper surface of the display panel 16 and outputs coordinates of a position touched with the pen or the finger to the cursor inside/outside determining unit 12 and the event generating unit 11. Because the touch sensor 15 is transparent, even if the touch sensor 15 is disposed on the upper surface of the display panel 16, the user can visually recognize the position of the cursor and the like displayed on the display panel 16.

The cursor drawing unit 13 allows the cursor to be displayed on the display panel 16 as well as define an inside/outside determining target region corresponding to the display position of the cursor. The inside/outside determining target region is a region defined with respect to the display position of the image object (the cursor in this exemplary embodiment) as a target for inside/outside determination of the touch position of the pen or the finger. The cursor in this exemplary embodiment is so large that its outer edge is displayed to be visually recognizable. For example, the cursor drawing unit 13 may allow the cursor as a circle of certain size to be displayed. In this exemplary embodiment, a region surrounded by the outer edge of the cursor is defined as the inside/outside determining target region. To display the outer edge of the cursor to be visually recognizable and define the region surrounded by the outer edge of the cursor as the inside/outside determining target region unit to display the inside/outside determining target region so that its outer edge can be visually recognized. However, the outer edge of the cursor does no need to match the outer edge of the inside/outside determining target region. When allowing a figure having a visually recognizable outer edge as the cursor to be displayed on the display panel 16 as in this exemplary embodiment, the cursor drawing unit 13 allows the cursor to be displayed so that the image object on the inner side the outer edge can be visually recognized. For example, only the outer edge may be displayed or the region surrounded by the outer edge is displayed translucent.

When the pen or the finger touches the touch sensor 15 and the touch sensor 15 outputs information (coordinates) of the touch position, the cursor inside/outside determining unit 12 determines whether the touch position is located inside or outside the inside/outside determining target region (the region surrounded by the outer edge of the cursor in this exemplary embodiment). A result of inside/outside determination of the touch position of the pen or the finger with respect to the inside/outside determining target region is hereinafter referred to as merely inside/outside determining result.

The event generating unit 11 generates different events depending on whether the touch position is located inside or outside the inside/outside determining target region. More specifically, the event generating unit 11 generates the event based on the inside/outside determining result obtained by the cursor inside/outside determining unit 12 and the state of the operation made with the pen or the finger to the displayed cursor. The event unit a signal indicating the operation performed with respect to the image object (the cursor in this exemplary embodiment) and is outputted to the application executing unit 17. When the event (signal) is generated, the application executing unit 17 executes processing corresponding to the event.

The event generating unit 11 stores the processing state of the image object control system 1 in the state storage unit 14. Examples of the processing state of the image object control system 1 include an initial state where there is no touch of the pen or the finger, various states where the event is determined based on the inside/outside determining result and the operation performed with respect to the displayed cursor, and various states where the cursor is being moved (below-mentioned “drag state” and “relative move” state).

The state storage unit 14 is a storage device that stores the processing state of the image object control system 1 therein.

The cursor drawing unit 13, the cursor inside/outside determining unit 12 and the event generating unit 11 are realized by, for example, a CPU that operates under a program (image object control program).

The application executing unit 17 can be also realized by the CPU that operates according to the application.

For example, the image object control program and the application may be stored in a program storage device (not shown) provided in the image object control system 1. Then, the CPU may read the image object control program and the application, operate as the cursor drawing unit 13, the cursor inside/outside determining unit 12 and the event generating unit 11 under the image object control program, and operate as the application executing unit 17 according to the application.

Next, operations will be described below. Although operations in the case of touching the touch sensor 15 with the pen are hereinafter described, operations in the case of touching the touch sensor 15 with the finger are made in a similar way.

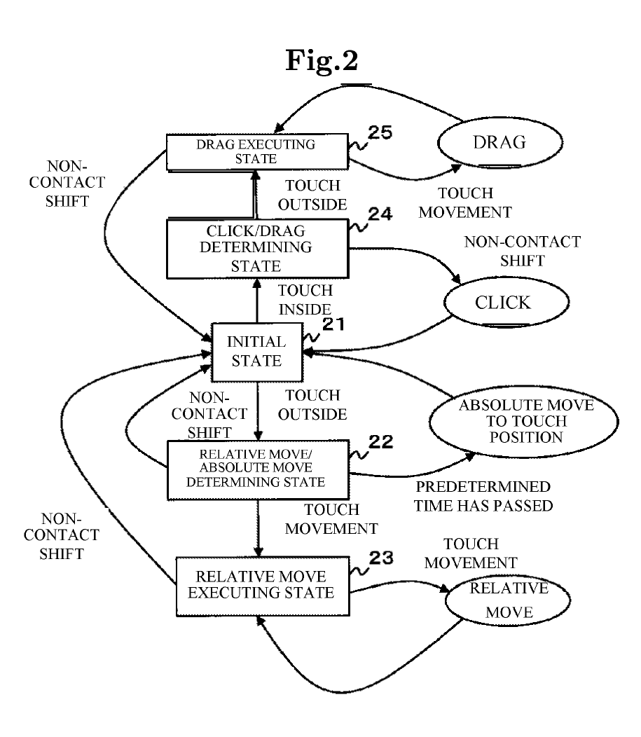

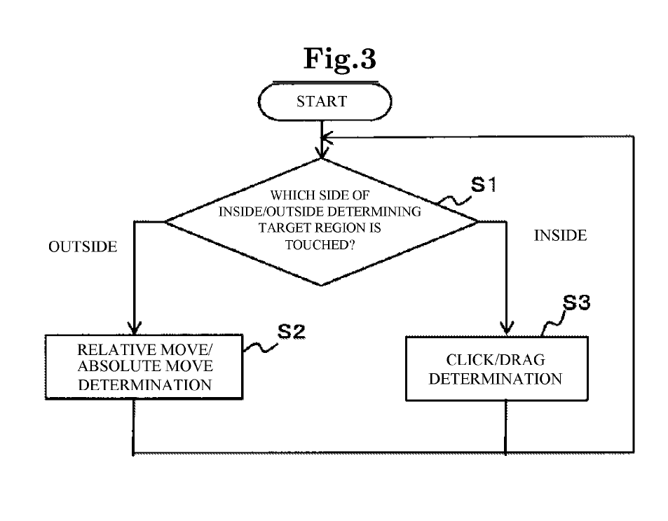

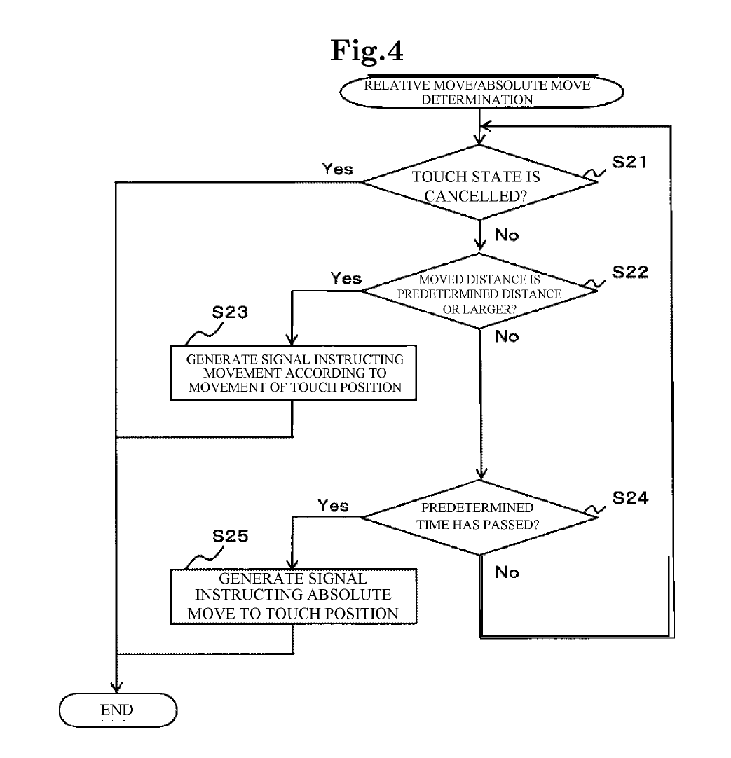

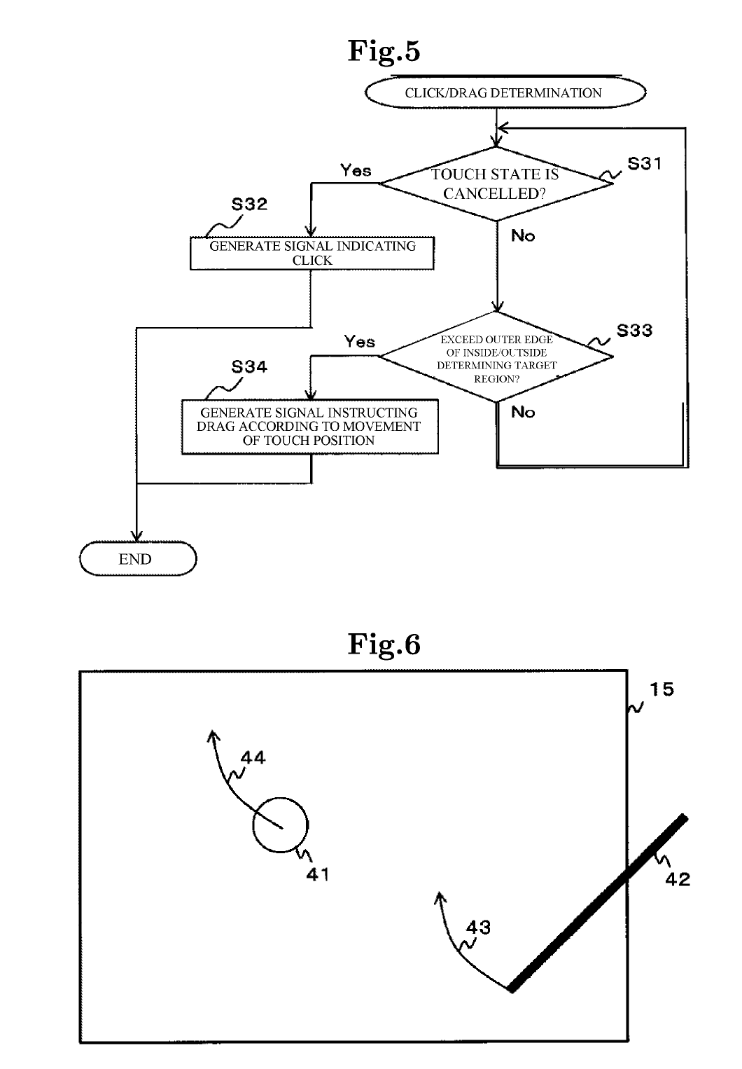

FIG. 2 is a diagram illustrating shift of the processing state of the image object control system 1. States 21 to 25 each expressed by a rectangular block in FIG. 2 represent the processing state of the image object control system 1. Each ellipse in FIG. 2 represents an event (signal). FIG. 3 is a flowchart showing an example of processing progress in this exemplary embodiment. FIG. 4 is a flowchart showing an example of Step S2 (relative move/absolute move determining processing) in FIG. 3. FIG. 5 is a flowchart showing an example of Step S3 (click/drag determining processing) in FIG. 3.

In the initial state 21 shown in FIG. 2, the cursor drawing unit 13 allows the cursor to be displayed on the display panel 16 while waiting touch onto the touch sensor 15 with the pen. In the initial state 21, the event generating unit 11 stores information indicating that the processing is in the initial state 21 in the state storage unit 14.

When the pen touches the touch sensor 15 in the initial state, the touch sensor 15 outputs coordinates of the touch position to the event generating unit 11 and the cursor inside/outside determining unit 12. When the state stored in the state storage unit 14 is the initial state 21, the cursor inside/outside determining unit 12 waits inputting of the coordinates of the touch position from the touch sensor 15, and when the coordinates of the touch position are inputted, determines whether the touch position of the pen is located inside or outside the inside/outside determining target region of the cursor (refer to Step S1 in FIG. 3). When allowing the cursor to be displayed, the cursor drawing unit 13 decides the inside/outside determining target region in advance. In this exemplary embodiment, it is assumed that the cursor drawing unit 13 allows the outer edge of a circle to be displayed as the cursor and decides a circular region surrounded by the outer edge as the inside/outside determining target region.

When the cursor inside/outside determining unit 12 performs the inside/outside determination, the event generating unit 11 refers to the inside/outside determining result. When the inside/outside determining result shows that the touch position is located outside the inside/outside determining target region, the event generating unit 11 stores information indicating that the processing is in the relative move/absolute move determining state 22 (refer to FIG. 2) in the state storage unit 14 and executes the relative move/absolute move determining processing (refer to Step S2 in FIG. 3). As a result, in FIG. 2, the initial state 21 shifts to the relative move/absolute move determining state 22.

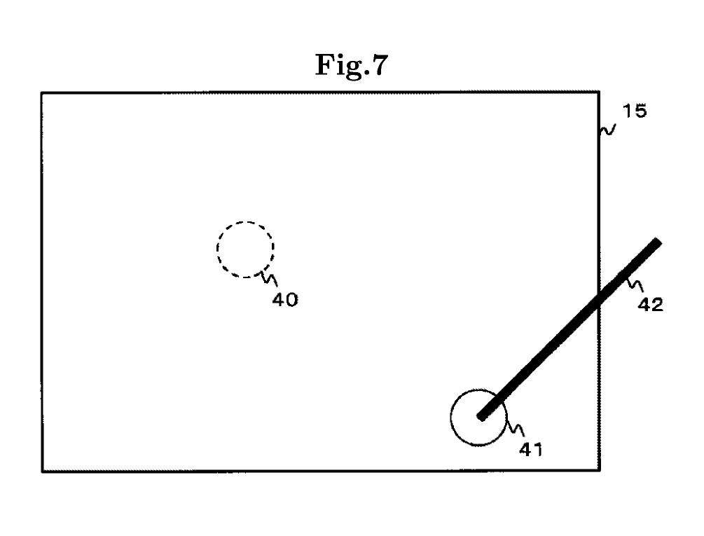

The relative move/absolute move determining processing is processing of determining whether a movement mode of the cursor is set to relative move or absolute move. In the relative move, according to movement of the touch position of the pen in the outside of the inside/outside determining target region (that is, movement of the pen), the cursor is moved. In other words, as the touch position of the pen moves from the touch position at start of touch as a start point, the cursor is similarly moved from the display position of the cursor in the initial state 21 as a start point. When the cursor is moved according to the movement of the touch position, a moved distance of the cursor may be changed according to the acceleration of the movement of the touch position. FIG. 6 is a diagram illustrating an example of the relative move. It is assumed that, as shown in FIG. 6, a cursor 41 is displayed and a pen 42 touches the outside of the cursor 41 (outside of the inside/outside determining target region) on the touch sensor 15. In the relative move, the cursor 41 is moved from its display position in the initial state along a path 44 that is similar to a path 43 of the touch position of the pen 42. As described above, the moved distance of the cursor 41 may be changed according to the acceleration of the movement of the touch position. In the absolute move, the position of the cursor is moved to the touch position of the pen. FIG. 7 is a diagram illustrating an example of the absolute move. For example, in FIG. 7, a position 40 is the display position of the cursor in the initial state. As shown in FIG. 7, in the absolute move, the cursor 41 is moved from the position 40 in the initial state to the touch position of the pen 42.

Referring to FIG. 4, an example of the relative move/absolute move determining processing will be described. When the procedure shifts to relative move/absolute move determining processing, the touch position of the pen is located outside the inside/outside determining target region. The event generating unit 11 determines whether or not the touch state of the pen is cancelled (Step S21). In other words, the event generating unit 11 determines whether or not the pen is detached from the touch sensor 15. For example, the event generating unit 11 may determine that the pen is detached from the touch sensor 15 (that is, the touch state is cancelled) if information indicating that the pen does not touch the touch sensor 15 is inputted from the touch sensor 15, and determine that the pen is not detached from the touch sensor 15 if the coordinates of the touch position of the pen are inputted from the touch sensor 15.

When the pen is not detached from the touch sensor 15 (No in Step S21), the event generating unit 11 determines whether or not the moved distance from the touch position at start of touch of the pen to the current touch position is a predetermined distance or larger (Step S22). When the moved distance of the touch position is the predetermined distance or larger (Yes in Step S22), the event generating unit 11 determines that the relative move is to be performed and generates an event instructing to move the cursor according to the movement of the touch position (Step S23). The event generating unit 11 stores information indicating that the processing is in the relative move executing state 23 (refer to FIG. 2) in the state storage unit 14. In the relative move executing state 23, while the touch position is moved, the operation of generating the event instructing to move the cursor according to the movement of the touch position is continued. In response to the event, the application executing unit 17 performs processing accompanying the movement of the cursor and the cursor drawing unit 13 moves the cursor according to the movement of the touch position of the pen. In Step S24, when the pen is detached from the touch sensor 15, the event generating unit 11 stores information indicating that the processing is in the initial state in the state storage unit 14 and the relative move executing state returns to the initial state.

When the moved distance of the touch position is less than the predetermined distance (No in Step S22), the event generating unit 11 determines whether or not a predetermined time has passed from start of touch of the pen (Step S24). When the predetermined time has passed from the start of touch of the pen (Yes in Step S24), the event generating unit 11 determines that the absolute move is to be performed and generates an event instructing to move the cursor to the touch position (Step S25). In response to the event, the application executing unit 17 performs processing accompanying the movement of the cursor and the cursor drawing unit 13 moves the cursor to the touch position of the pen. Then, the event generating unit 11 stores information indicating that the processing is in the initial state in the state storage unit 14 and the procedure returns to the initial state.

When the predetermined time has not passed from the start of touch of the pen (No in Step S24), the event generating unit 11 repeats the processing in Step S21 and the subsequent steps. When the moved distance of the touch position is still less than the predetermined distance and the pen is detached from the touch sensor 15 before the predetermined time has passed from the start of touch of the pen (Yes in Step S21), the event generating unit 11 finishes the relative move/absolute move determining processing. Then, the event generating unit 11 stores information indicating that the processing is in the initial state in the state storage unit 14 and the procedure returns to the initial state.

It can be said that the above-mentioned predetermined distance is a threshold of the moved distance for relative move/absolute move determination. Further, it can be said that the above-mentioned predetermined time is a threshold of time for relative move/absolute move determination. The predetermined distance and the predetermined time (thresholds of the moved distance and the time for relative move/absolute move determination) each are not limited to a fixed value and may be variable. For example, the values may be changed according to the application executed by the application executing unit 17 and neighboring image objects.

When it is determined that the touch position is located inside the inside/outside determining target region in Step S1, information indicating that the processing is in the click/drag determining state 24 (refer to FIG. 2) is stored in the state storage unit 14 and the click/drag determining processing (refer to Step S3 in FIG. 3) is executed. As a result, the procedure shifts from the initial state 21 to the click/drag determining state 24 in FIG. 2.

The click/drag determining processing is processing of determining whether the operation performed with respect to the cursor is a drag operation or a click operation. Drag unit moving the image object to be operated while being kept in a specific state. The specific state only needs to be a state other than mere movement of the cursor. For example, drag of the cursor can specify a range on the touch sensor 15. When attempting to move the cursor for such specification, the user drags the cursor. However, such range specification is an only example and the user may drag the cursor for purposes other than range specification. For example, the specific state corresponds to a state where the user clicks a button when performing the drag operation with a general mouse with button. According to the present invention, without such button operation, the drag operation is determined based on the touch position and movement of the touch position.

Referring to FIG. 5, an example of click/drag determining processing will be described. When the procedure shifts to the click/drag determining processing, the touch position of the pen is located inside the inside/outside determining target region. The event generating unit 11 first determines whether or not the touch state of the pen is cancelled (Step S31). The determination is performed in a similar way to that in Step S21 (refer to FIG. 4).

When it is determined that the pen is detached from the touch sensor 15 in Step S31 (Yes in Step S31), the event generating unit 11 generates an event indicating click at the cursor position (Step S32). In response to the event, the application executing unit 17 performs processing accompanying click at the cursor position and the cursor drawing unit 13 continues drawing of the cursor at the same position. The event generating unit 11 stores information indicating that the processing is in the initial state in the state storage unit 14 and the procedure returns to the initial state.

When the pen is not detached from the touch sensor 15 (No in Step S31), referring to change of coordinates of the touch position of the pen, which are inputted from the touch sensor 15, the event generating unit 11 determines whether or not the touch position of the pen moves to the outer edge of the inside/outside determining target region and further to the outside of the inside/outside determining target region (Step S33). When the touch position moves to the outer edge of the inside/outside determining target region and further to the outside of the inside/outside determining target region (Yes in Step S33), the event generating unit 11 determines that the processing is in the drag executing state 25 (refer to FIG. 2) and generates an event instructing drag according to the movement of the touch position (Step S34). Further, the event generating unit 11 stores information indicating that the processing is in the drag executing state 25 in the state storage unit 14. In the drag executing state 25, while the movement of the touch position continues, the operation of generating the event instructing drag according to the movement of the touch position is continued. In response to the event, the application executing unit 17 performs processing accompanying drag of the cursor, and the cursor drawing unit 13 moves the cursor according to the movement of the touch position of the pen.

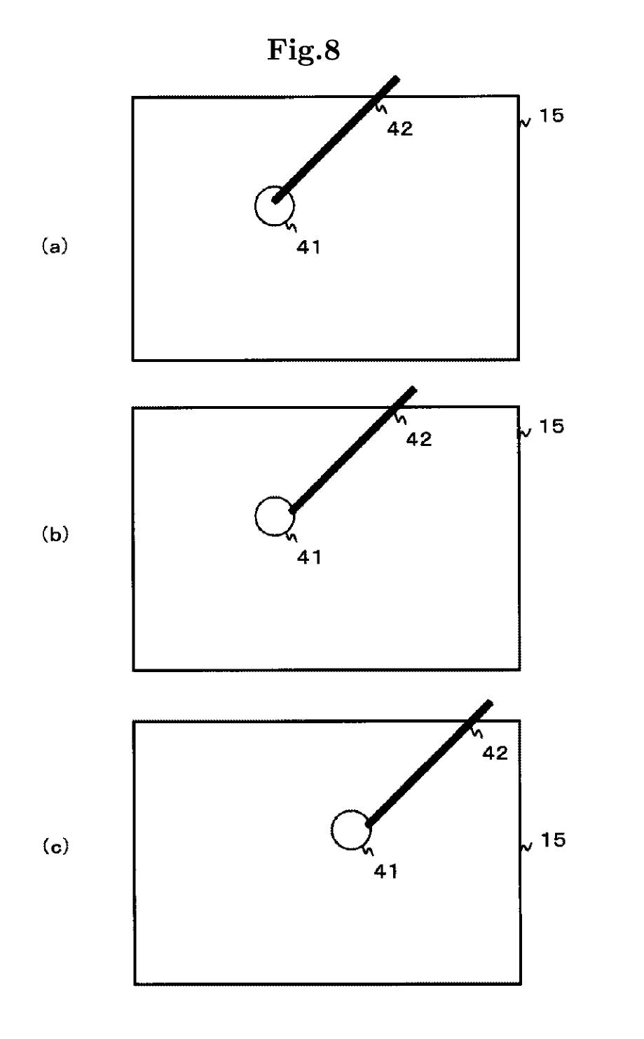

FIG. 8 is a diagram illustrating an example of drag of the cursor. As shown in FIG. 8(a), it is assumed that the pen 42 touches the touch sensor 15 on the inner side of the outer edge of the cursor 41 (that is, the inside of the inside/outside determining target region) and the procedure proceeds to Step S33. In this case, as shown in FIG. 8(b), by the time when the touch position reaches the outer edge of the inside/outside determining target region, the event generating unit 11 does not generate an event instructing to move the cursor in the drag operation. After that, when the touch position moves to the outside of the inside/outside determining target region, the event generating unit 11 generates the event instructing to move the cursor in the drag operation. As a result, as shown in FIG. 8(c), as the touch position moves, the cursor 41 also moves.

In Step S34, when the pen is detached from the touch sensor 15, the event generating unit 11 stores information indicating that the processing is in the initial state in the state storage unit 14 and the procedure returns to the initial state.

In Step S33, when the touch position does not move to the outside of the inside/outside determining target region (No in Step S33), the event generating unit 11 returns to Step S31 and repeats the processing in Step S31 and the subsequent steps.

According to the above-mentioned click/drag determining processing, if the pen touches the inside of the inside/outside determining target region and the touch position moves to the outer edge of the inside/outside determining target region and further to the outside of the inside/outside determining target region, the event generating unit 11 generates the event instructing drag. If the pen is detached from the touch sensor 15 before the touch position of the pen moves to the outside of the inside/outside determining target region, the event generating unit 11 generates the event indicating click.

In this exemplary embodiment, when the pen touches the outside of the inside/outside determining target region (for example, the region surrounded by the outer edge of the cursor) and the moved distance of the touch position of the pen becomes the predetermined distance (threshold of the moved distance for relative move/absolute move determination) or more, the event generating unit 11 generates the event instructing to move the cursor according to the movement of the touch position. For example, the event generating unit 11 generates an event instructing to move the cursor from its current display position along the same path as that of the touch position. Accordingly, the cursor can be moved in the outside of the inside/outside determining target region according to movement of the pen. Therefore, since the user can move the cursor by operating the pen in a wide region away from the cursor, the moved distance can be properly adjusted with ease. As a result, the operation performed with respect to the cursor (the operation of moving the cursor in this exemplary embodiment) can be accurately performed. In addition, since the cursor can be moved by operating the pen in the place away from the cursor, the neighborhood of the cursor as a user's attention region cannot be visually interrupted by the pen, resulting in improvement of operability of the user.

When the pen touches the outside of the inside/outside determining target region and the predetermined time has passed while the moved distance of the touch position of the pen is less than the predetermined distance, the event generating unit 11 generates an event instructing to move the cursor to the touch position of the pen. Consequently, since the operation of moving the cursor to a distant position can be achieved only by performing a simple operation of touching the pen at a desired position and waiting that the predetermined time has passed in this state (that is, long-pressing the desired position with the pen), a stress exerted when the cursor is moved to the distant position can be released. Moreover, it is possible to improve intuitiveness of the operation of moving the cursor to the desired position.

When the pen touches the inside of the inside/outside determining target region and the pen is detached from the touch sensor 15 before the touch position of the pen moves to the outside of the inside/outside determining target region, the event generating unit 11 generates an event indicating click at the cursor position. As long as the touch position is located inside the inside/outside determining target region, the event generating unit 11 generates the same event. Accordingly, when attempting to perform the click operation, the user only needs to touch the inside of the inside/outside determining target region with the pen and then, release the pen. As described above, since there is no such limitation that the user must accurately touch a very small limited point, the user's operability can be improved. Further, click can be achieved by the intuitive operation of touching the inside of the inside/outside determining target region with the pen and then, releasing the pen, which is easily understandable.

When the pen touches the inside of the inside/outside determining target region and the touch position moves to the outer edge of the inside/outside determining target region, and further to the outside of the inside/outside determining target region, the event generating unit 11 generates the event instructing drag according to movement of the touch position. Accordingly, the operation of dragging the cursor can be matched with the user's intuition. Moreover, since the cursor starts to move in the drag operation after the touch position moves to the outer edge of the inside/outside determining target region, a boundary between the inside and the outside of the cursor seems to be pulled. For this reason, it is possible to overcome the problem that the neighborhood of the cursor is hard to see due to existence of the pen immediately above the cursor.

When comparing the touch pad with the image object control system in this exemplary embodiment, in the touch pad, in order to perform click and drag, it is need to further operate the button or perform a special gesture, which is not intuitive. On the contrary, in this exemplary embodiment, as described above, click and drag can be performed by the intuitive operations.

As has been described, in this exemplary embodiment, the cursor can be accurately operated in the relative move. Moreover, click, movement and drag can be achieved by the intuitive and understandable operations. In other words, operational accuracy (accuracy) and understandability can coexist.

Next, modification examples of this exemplary embodiment will be described. In the above-mentioned system, the absolute move and the relative move may be performed while keeping drag. That is, even when the pen is detached from the touch panel, the absolute move and the relative move can be performed while keeping the cursor in the specific state. Hereinafter, that the cursor can be dragged even when the pen or the finger is detached from the touch panel is referred to as drag lock.

In order to perform drag lock, when the procedure proceeds to Step S34 in FIG. 5 and the event generating unit 11 generates a signal instructing drag so that the processing is in the drag executing state, the event generating unit 11 may further generate a signal maintaining drag, turns a drag lock flag ON and performs the operation in Step S34. Even when the drag lock flag is in the ON state and the pen is detached from the touch sensor, the event generating unit 11 keeps the drag lock flag ON to maintain the drag state.

Operations in Step S21 and subsequent steps in the case where the drag lock flag is turned OFF (refer to FIG. 4) are the same as those described above.

When the processing state becomes the initial state while the drag lock flag still remains to be ON and then, the pen touches the outside of the inside/outside determining target region, and it is determined that the relative move is to be performed through the processing in Step S21 and the subsequent steps (refer to FIG. 4), an event instructing to move the cursor in the specific state according to the movement of the touch position may be generated (Step S23 in FIG. 4). When it is determined that the absolute move is to be performed, an event instructing to move the cursor in the specific state to the touch position may be generated (Step S25 in FIG. 4). Thereby, it is possible to move the cursor along the path of the pen in the outside of the inside/outside determining target region (relative move) or move the cursor to the touch position of the pen in the outside of the inside/outside determining target region (absolute move), while maintaining the drag state of the cursor.

When the procedure proceeds to Step S32 while the drag lock flag is turned ON (refer to FIG. 5), the event generating unit 11 turns the drag lock flag OFF in place of generating an event indicating that the cursor is clicked. That is, when the pen touches the inside of the inside/outside determining target region while the drag state of the cursor is maintained, and the pen is detached from the touch sensor 15 before the touch position of the pen moves to the outside of the inside/outside determining target region, the event generating unit 11 cancels the drag state of the cursor. Therefore, when attempting to cancel the drag state of the cursor, the user may touch the inside of the inside/outside determining target region with the pen and then, release the pen.

When the drag lock flag is turned ON, it is preferred that the cursor drawing unit 13 changes a display mode of the cursor, for example, by changing color of the cursor. In this case, even when the pen or the like is detached from the touch sensor, the user can recognize whether or not the cursor is dragged based on the display state of the cursor.

With such configuration, drag lock can be realized. That is, even when the pen or the like is detached from the dragged cursor, the user can perform the relative move and the absolute move with respect to the dragged cursor. When drag lock is cancelled, the user may click the inside of the inside/outside determining target region of the cursor.

In the above description, when the moved distance of the touch position from the touch position at start of touch of the pen is less than predetermined distance and the predetermined time has passed since the pen touches the touch sensor 15 (Yes in Step S22), the event generating unit 11 generates the event instructing to move the cursor to the touch position (absolute move) (Step S23). In this determination, “the moved distance of the touch position is 0” may be set as a condition of the moved distance of the touch position for the absolute move. In this case, the event generating unit 11 may determine whether or not the moved distance of the touch position exceeds 0 in Step S22 and proceeds to Step S23 when the moved distance of the touch position exceeds 0. When the moved distance of the touch position is 0, the event generating unit 11 may determine whether or not the predetermined time has passed from start of touch (Step S24). Then, when the moved distance of the touch position is 0 and the predetermined time has passed, the event generating unit 11 may proceed to Step S25 and generate a signal instructing the absolute move. In other words, when the predetermined time has passed while the touch position remains unchanged, the event generating unit 11 may generate the event instructing to move the cursor to the touch position.

Alternatively, the event generating unit 11 may determine whether to perform the relative move or the absolute move based on the moved distance of the touch position with disregard to passage of time since the pen touches the touch sensor 15. In this case, when the pen touches the outside of the inside/outside determining target region and the moved distance of the touch position becomes the predetermined distance or larger (or exceeds 0), the event generating unit 11 generates the event instructing to move the cursor according to the movement of the touch position (relative move). When the moved distance of the touch position is less than the predetermined distance (or is 0), the event generating unit 11 waits by the time when the pen is detached from the touch sensor 15, and generates the event instructing to move the cursor to the touch position (absolute move) when the pen is detached from the touch sensor 15 and the moved distance of the touch position becomes smaller than the predetermined distance (or becomes 0).

In the above-mentioned exemplary embodiment, there is one type of event indicating click. However, when the cursor is operated with a mouse with a plurality of buttons or the like, it is possible to perform a plurality of click operations such as right click and left click. According to the present invention, plural types of events indicating click may be generated. Hereinafter, using two types of click as an example, one is referred to as first click and the other is referred to as second click. For example, the first click corresponds to left click in a mouse operation and the second click corresponds to right click in the mouse operation.

FIG. 9 is a flowchart showing an example of click/drag determination in the case where two types of click is used. The same steps as those in FIG. 5 are given the same reference numerals as those in FIG. 5 and description thereof is omitted. In this case, in the click/drag determination, when the touch position of the pen does not move to the outside of the inside/outside determining target region (No in Step S33), the event generating unit 11 determines whether or not a predetermined time for second click determination has passed from start of touch of the pen (Step S35). When the predetermined time for second click determination has passed from start of touch of the pen (Yes in Step S35), the event generating unit 11 generates an event indicating the second click at the cursor position (Step S36). In response to this event, the application executing unit 17 performs processing accompanying the second click at the cursor position, and the cursor drawing unit 13 continues drawing of the cursor at the same position. It can be said that the predetermined time for second click determination is a time threshold for second click determination. When the predetermined time for second click determination has not passed from start of touch of the pen (No in Step S35), the event generating unit 11 repeats processing in Step S31 and the subsequent steps.

When the touch position does not move to the outside of the inside/outside determining target region and the pen is detached from the touch sensor 15 before the predetermined time for second click determination has passed (Yes in Step S31), the event generating unit 11 generates an event indicating the first click at the cursor position. This processing is the same as the above-mentioned processing in Step S32 (refer to FIG. 5).

In the above-mentioned example, plural types of click: the first click (for example, corresponds to the left click) in the case of a short touch time to the cursor and the second click in the case of a long touch time to the cursor can be informed to the application executing unit 17 (refer to FIG. 1).

When performing double click, the user may repeat twice an operation of touching the inside of the inside/outside determination target region of the cursor with the pen and then, releasing the pen. As a result, the event generating unit 11 generates the event indicating click at the same cursor position twice in a row. When two events indicating click at the same cursor position are generated within a time that is smaller than a time threshold for double click determination, the application executing unit 17 may perform processing corresponding to double click. Alternatively, when a time from shift to Step S32 to re-shift to Step S32 is smaller than the time threshold for double click determination, the event generating unit 11 may generate an event indicating double click at the cursor position.

Although it is difficult to touch the exactly same coordinates with the pen, by touching the inside of the inside/outside determination target region with the pen, the user need not touch the exact same position twice. In this manner, double click can be easily achieved.

In the above-mentioned system, when the pen is detached from the touch sensor and touches the touch sensor again, in the case where a time during which the pen is detached from the touch sensor is less than a threshold for wrong operation determination, it may be determined that the pen is not detached from the touch sensor. For example, in the drag executing state 25 shown in FIG. 2, when the pen is detached from the touch sensor and touches the inside of the inside/outside determination target region again within a time that is less than the threshold for wrong operation determination, the drag executing state 25 may be continued without being interrupted. Then, in the drag executing state 25, when the pen is detached from the touch sensor and does not touch again before the time threshold for wrong operation determination has passed, the drag executing state 25 may return to the initial state 21.

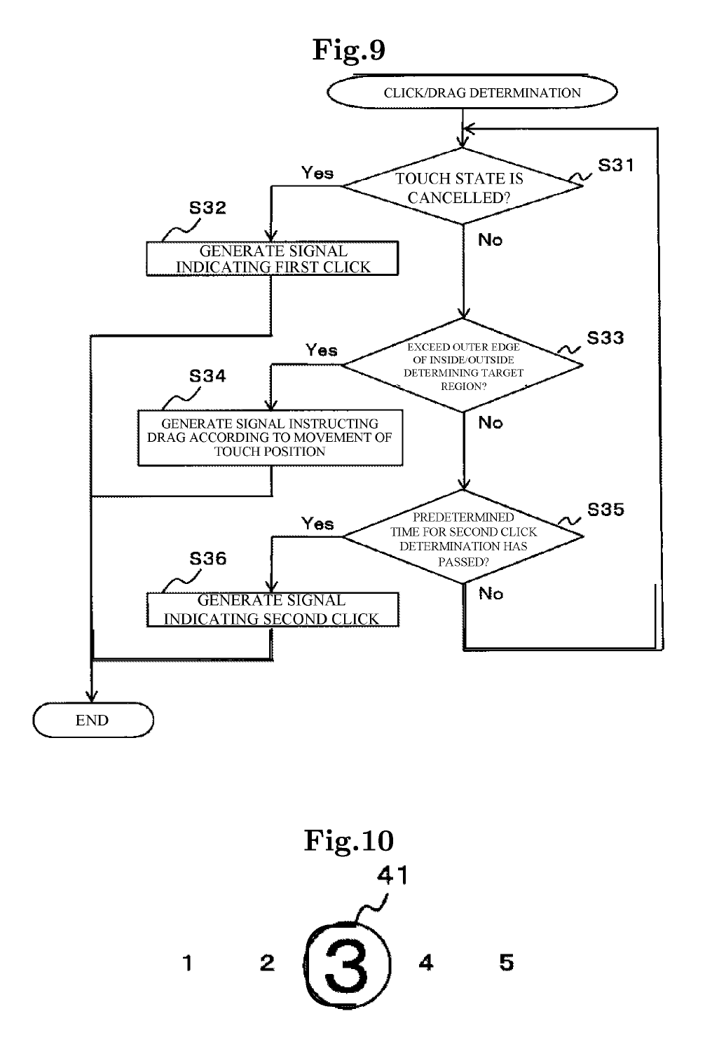

In the above-mentioned exemplary embodiment, the cursor drawing unit 13 may display an enlarged image of the region surrounded by the outer edge of the cursor. FIG. 10 is a diagram illustrating an example of a displayed enlarged image of the region surrounded by the outer edge of the cursor. FIG. 10 shows the case where numerals “1” to “5” are displayed and the cursor 41 exists at a position of “3”. In this case, as shown in FIG. 10, the cursor drawing unit 13 may display enlarged “3”. When the cursor 41 moves to a position of another numeral, the cursor drawing unit 13 enlarges the numeral and displays “3” of original size. In an enlarged figure, a part that does not fit into the inner side of the outer edge of the cursor is not displayed. By enlarging the image within the cursor in this manner, when the relative move is performed, the image at the cursor position can be presented to the user in detail, so that the user can operate the cursor more easily. Especially when the area of the display panel 16 (refer to FIG. 1) is small and individual icons displayed on the display panel 16 are small, images of these icons cannot be presented to the user in detail.

When the pen does not touch the touch sensor for a certain time, the cursor drawing unit 13 may stop display of the cursor. That is, the cursor may be cleared from the display panel 16. When the pen touches the touch sensor in the state where the cursor is cleared, the cursor drawing unit 13 may display the cursor at the touch position. With such configuration, when the operation is not performed for the certain time, the image on the display panel 16 can be made easily viewable by clearing the cursor from the display panel 16. When the area of the display panel 16 is so small that the cursor is noticeable, this configuration has an especially large effect. By making the cursor smaller in place of clearing the cursor, the cursor may be deformed so as not to be noticeable.

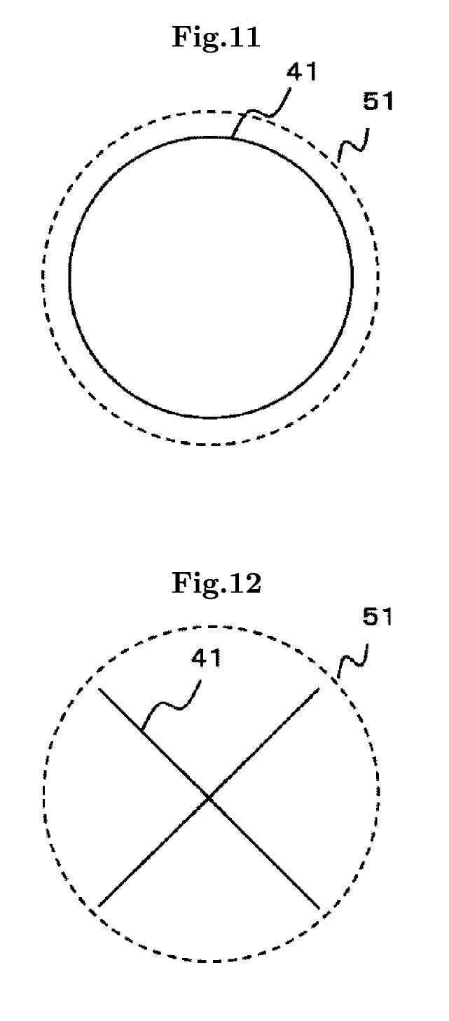

In the above-mentioned exemplary embodiment, the case where the outer edge of the cursor and the outer edge of the inside/outside determining target region match each other is described as an example. However, as described above, the outer edge of the cursor and the outer edge of the inside/outside determining target region do not need to match each other. FIG. 11 is a diagram illustrating an example of the case where the outer edge of the cursor and the outer edge of the inside/outside determining target region do not match each other. For example, the cursor drawing unit 13 may display the cursor 41 and at this time, define an inside/outside determining target region 51 that is larger than the cursor 41 as an inside/outside determining target region corresponding to the display position of the cursor 41. Alternatively, the inside/outside determining target region 51 may be smaller than the cursor 41. In FIG. 11, the cursor 41 is displayed, while the inside/outside determining target region 51 is not displayed. In order to present the inside/outside determining target region 51 to the user through intuition, it is preferred that the outer edge of the cursor and the outer edge of the inside/outside determining target region 51 match each other.

The cursor does not need to be a figure surrounded by an outer edge. FIG. 12 shows an example of a case where an “X”-shaped figure that is not surrounded by an outer edge is used as the cursor. Even when such figure is used as the cursor, in displaying the cursor 41, the cursor drawing unit 13 defines the inside/outside determining target region 51 corresponding to the display position of the cursor 41 (refer to FIG. 12). However, in order to present the inside/outside determining target region 51 to the user through intuition, it is preferred that a figure surrounded by the outer edge is used as the cursor and that the outer edge of the cursor and the outer edge of the inside/outside determining target region 51 match each other.

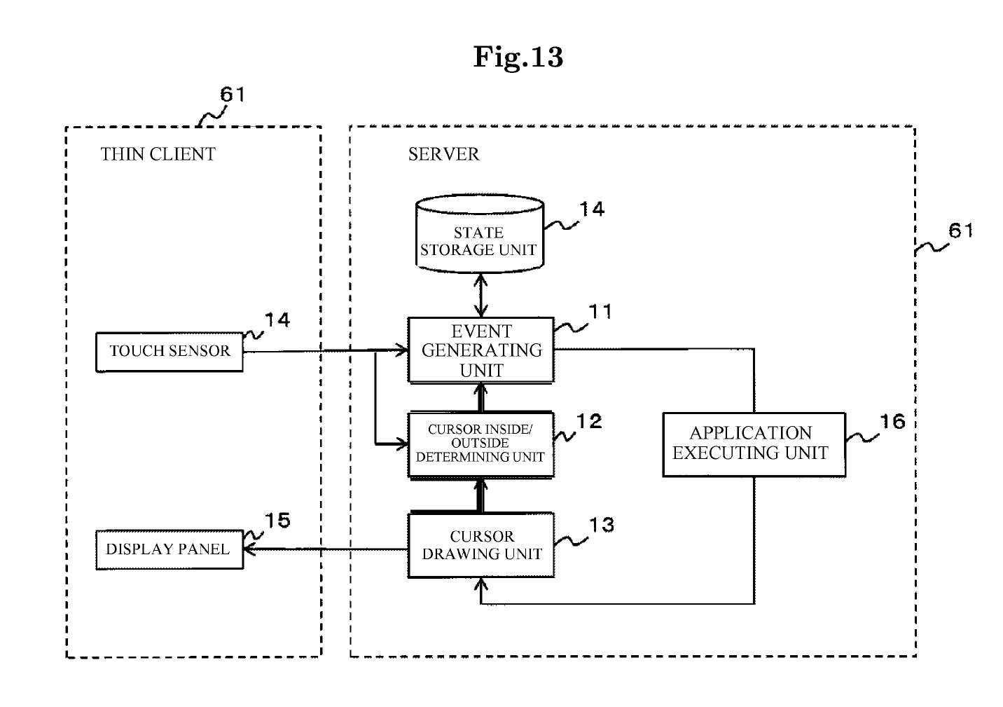

The image object control system may include a server and a terminal. FIG. 13 is a diagram illustrating an example of configuration of an image object control system provided with the server and the terminal. The same components as those in FIG. 1 are given the same reference numerals as those in FIG. 1 and detailed description thereof is omitted. As shown in FIG. 13, a thin client (terminal) 62 may include the display panel 16 and the touch sensor 15, and a server 61 may include the event generating unit 11, the cursor inside/outside determining unit 12, the cursor drawing unit 13, the state storage unit 14 and the application executing unit 17.

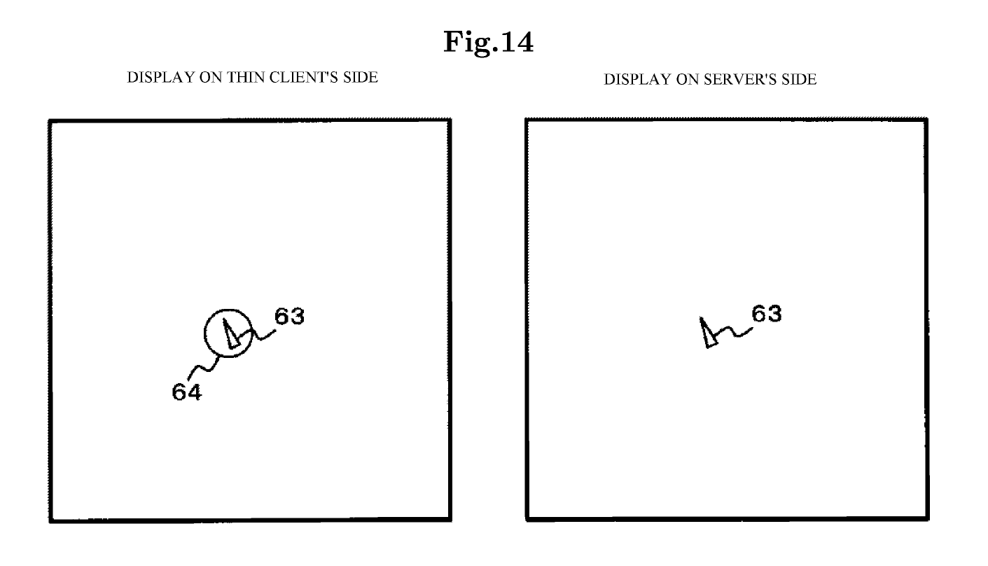

The server and the thin client each may include the display panel and display a similar screen. FIG. 14 is a diagram illustrating an example of images displayed on the side of the server and the thin client. The server displays an image containing a cursor 63. The thin client displays an image containing the cursor 63, which is similar to the image displayed on the server's side. The thin client further displays a second cursor 64 for moving the cursor 63 displayed on the server's side. According to the method described in the above-mentioned exemplary embodiment, the thin client may move the second cursor 64 and the server may move the cursor 63 according to the movement of the second cursor 64 displayed on the thin client's side.

In the above-mentioned exemplary embodiment and its modification examples, the case where the pen touches the touch sensor is described. However, an operation of touching the touch sensor with a finger in place of the pen to move the cursor may be performed. An operation of touching the touch sensor with a contact body other than the pen and the finger is also possible. Even when the contact body other than the pen is used, operations of the image object control system are the same as those in using the pen.

In the above description, the cursor is used as an example of the image object. However, the same operations may be performed with respect to the image object other than the cursor as in the above-mentioned exemplary embodiment and its modification examples. For example, when an icon is previously selected, the relative move, the absolute move, click and drag of the icon may be performed according to similar methods to the above-mentioned methods.

### Second Exemplary Embodiment

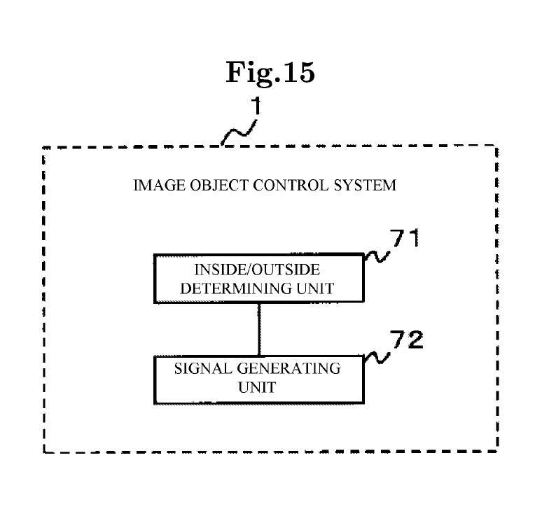

Next, Second exemplary embodiment of the present invention will be described with reference to FIG. 15. FIG. 15 is a block diagram showing summary of the present invention. In this exemplary embodiment, the summary of the image object control system will be described.

First, as shown in FIG. 15, the image object control system 1 in this exemplary embodiment includes an inside/outside determining unit 71 and a signal generating unit 72.

The inside/outside determining unit 71 (for example, the cursor inside/outside determining unit 12) determines whether the touch position of the contact body is located outside or inside the inside/outside determining target region that is defined with respect to the display position of the image object (for example, the cursor) as a target region for inside/outside determination of the touch position of the contact body.

When it is determined that the touch position of the contact body is located outside the inside/outside determining target region, the signal generating unit 72 generates a signal (for example, an event) indicating the operation performed with respect to the image object.

With such configuration, since the image object can be operated according to the movement of the contact body in a large region away from the image object, the image object can be accurately operated. In addition, since the neighborhood of the image object as the user's attention region is not visually interrupted by the contact body, the user's operability can be improved.

The above-mentioned exemplary embodiment discloses the configuration in which, when the touch position of the contact body is located outside the inside/outside determining target region, the signal generating unit 72 generates a signal instructing to move the image object as a signal indicating the operation performed with respect to the image object.

The above-mentioned exemplary embodiment also discloses the configuration in which, when the touch position of the contact body is located outside the inside/outside determining target region and the touch position moves, the inside/outside determining unit 72 generates a signal instructing to move the image object according to the movement of the touch position is generated. In particular, when it is determined that the touch position of the contact body is located outside the inside/outside determining target region and the moved distance of the touch position is the predetermined distance or larger, the inside/outside determining unit 72 generates a signal instructing to move the image object from the display position of the image object as a start point along the same path as that of the touch position. With such configuration, since the image object can be moved according to the movement of the contact body in the wide region away from the image object, the moved distance can be properly adjusted with ease, thereby accurately moving the image object to a desired position.

The above-mentioned exemplary embodiment also discloses the configuration in which, when it is determined that the touch position of the contact body is located outside the inside/outside determining target region and the moved distance of the touch position is less than the predetermined distance, the inside/outside determining unit 72 generates a signal instructing to move the image object to the touch position. The above-mentioned exemplary embodiment also discloses the configuration in which, when it is determined that the touch position of the contact body is located outside the inside/outside determining target region and the moved distance of the touch position is 0, the inside/outside determining unit 72 generates a signal instructing to move the image object to the touch position. With such configuration, a stress exerted when moving the image object to a distant position can be released. Moreover, the image object can be moved to the desired position by the intuitive operation.

The above-mentioned exemplary embodiment also discloses the configuration in which, when it is determined that the touch position of the contact body is located inside the inside/outside determining target region, the signal generating unit 72 generates a signal indicating an operation performed with respect to the image object, which is different from the operation performed when it is determined that the touch position of the contact body is located outside the inside/outside determining target region.

The above-mentioned exemplary embodiment also discloses the configuration in which, when it is determined that the touch position of the contact body is located inside the inside/outside determining target region and the touch state is cancelled before the touch position of the contact body moves to the outside of the inside/outside determining target region, the signal generating unit 72 generates a signal indicating click as a signal indicating an operation performed with respect to the image object. With such configuration, since the user only needs to touch any position within the inside/outside determining target region, the operability for click can be improved. Moreover, the intuitive click operation can be achieved.

The above-mentioned exemplary embodiment also discloses the configuration in which, when it is determined that the touch position of the contact body is located inside the inside/outside determining target region and the touch position moves to the outer edge of the inside/outside determining target region and further to the outside to the inside/outside determining target region, the signal generating unit 72 generates a signal instructing to drag the image object according to the movement of the touch position. With such configuration, the intuitive operation of moving the image object can be achieved. Moreover, it is possible to overcome the problem that the neighborhood of the image object is hard to see due to the existence of the contact body immediately above the image object.

The above-mentioned exemplary embodiment also discloses the configuration in which, the signal generating unit 72 generates the signal instructing drag as well as a signal maintaining the drag, and after that, when it is determined that the touch position of the contact body is located outside the inside/outside determining target region and the touch position moves, the signal generating unit 72 generates a signal instructing to move the image object to the touch position while maintaining drag of the image object. The above-mentioned embodiment also discloses the configuration in which, the signal generating unit 72 generates the signal instructing drag as well as a signal maintaining the drag, and after that, when it is determined that the touch position of the contact body is located inside the inside/outside determining target region and the touch state is cancelled before the touch position of the contact body moves to the outside of the inside/outside determining target region, the signal generating unit 72 cancels drag of the image object. With such configuration, the user can detach the contact body from the dragged image object and move the contact body in a wide region away from the image object to move the image object while maintaining the drag state. Moreover, the drag state can be easily cancelled.

The above-mentioned exemplary embodiment also discloses the configuration including an inside/outside determining target region display unit (for example, the cursor drawing unit 13) for displaying the inside/outside determining target region so that the outer edge of the inside/outside determining target region can be visually recognized. With such configuration, the inside/outside determining target region can be understandably presented to the user.

The above-mentioned exemplary embodiment also discloses that the image object is the cursor.

Here, the above-mentioned image object control system is realized by incorporating the image object control program into a computer.

Specifically, the image object control program is a program under which the computer executes

inside/outside determining processing of determining whether the touch position of the contact body is located outside or inside the inside/outside determining target region defined with respect to the display position of the image object as a target region for inside/outside determination of the touch position of the contact body, and

signal generating processing of generating a signal indicating an operation performed with respect to the image object when it is determined that the touch position of the contact body is located outside the inside/outside determining target region.

The above-mentioned image object control program is a program under which the computer executes

signal generating processing of generating a signal instructing to move the image object as the signal indicating the operation performed with respect to the image object when it is determined that the touch position of the contact body is located outside the inside/outside determining target region.

An image object control method is performed by activating the above-mentioned image object control system.

Specifically, the image object control method includes steps of

determining whether the touch position of the contact body is located outside or inside the inside/outside determining target region defined with respect to the display position of the image object as a target region for inside/outside determination of the touch position of the contact body, and

generating a signal indicating an operation performed with respect to the image object when it is determined that the touch position of the contact body is located outside the inside/outside determining target region.

The above-mentioned image object control method further includes a step of generating a signal instructing to move the image object as the signal indicating an operation performed with respect to the image object when it is determined that the touch position of the contact body is located outside the inside/outside determining target region.

Although the present invention has been described with reference to the above-mentioned exemplary embodiments, the present invention is not limited to the above-mentioned exemplary embodiments. Various modifications can be made to configuration and details of the present invention so as to be understandable for those skilled in the art within the scope of the present invention.

The present invention claims a priority based on the Japanese Patent Application No. 2008-242995 filed on Sep. 22, 2008 in Japan, the contents of which is incorporated hereinto by reference in its entirety.

The present invention can be preferably applied to the image object control system for performing an operation with respect to the image object such as the cursor.

1. An image object control system comprising:
an inside/outside determining unit for determining whether a touch position of a contact body is located outside or inside an inside/outside determining target region defined with respect to a display position of an image object as a target region for inside/outside determination of the touch position of the contact body; and
a signal generating unit for generating a signal indicating an operation performed with respect to the image object when it is determined that the touch position of the contact body is located outside the inside/outside determining target region.

2. The image object control system according to claim 1, wherein
when it is determined that the touch position of the contact body is located outside the inside/outside determining target region, the signal generating unit generates a signal instructing to move the image object as the signal indicating the operation performed with respect to the image object.

3. The image object control system according to claim 2, wherein
when it is determined that the touch position of the contact body is located outside the inside/outside determining target region and the touch position moves, the inside/outside determining unit generates a signal instructing to move the image object according to the movement of the touch position.

4. The image object control system according to claim 2, wherein
when it is determined that the touch position of the contact body is located outside the inside/outside determining target region and the moved distance of the touch position is a predetermined distance or larger, the inside/outside determining unit generates a signal instructing to move the image object from the display position of the image object as a start point along the same path as that of the touch position.

5. The image object control system according to claim 2, wherein
when it is determined that the touch position of the contact body is located outside the inside/outside determining target region and the moved distance of the touch position is less than predetermined distance, the inside/outside determining unit generates a signal instructing to move the image object to the touch position.

6. The image object control system according to claim 2, wherein
when it is determined that the touch position of the contact body is located outside the inside/outside determining target region and the moved distance of the touch position is 0, the inside/outside determining unit generates a signal instructing to move the image object to the touch position.

7. The image object control system according to claim 1, wherein
when it is determined that the touch position of the contact body is located inside the inside/outside determining target region, the signal generating unit generates a signal indicating an operation performed with respect to the image object, which is different from the operation made when it is determined that the touch position of the contact body is located outside the inside/outside determining target region.

8. The image object control system according to claim 7, wherein
when it is determined that the touch position of the contact body is located inside the inside/outside determining target region and the touch state is cancelled before the touch position of the contact body moves to the outside of the inside/outside determining target region, the signal generating unit generates a signal indicating click as the signal indicating the operation performed with respect to the image object.

9. The image object control system according to claim 7, wherein
when it is determined that the touch position of the contact body is located inside the inside/outside determining target region and the touch position moves to an outer edge of the inside/outside determining target region and further to the outside of the inside/outside determining target region, the signal generating unit generates a signal instructing to drag of the image object according to the movement of the touch position.

10. The image object control system according to claim 9, wherein
the signal generating unit generates the signal instructing drag as well as a signal maintaining the drag, and after that, when it is determined that the touch position of the contact body is located outside the inside/outside determining target region and the touch position moves, generates a signal instructing to move the image object according to the movement of the touch position while maintaining drag of the image object.

11. The image object control system according to claim 9, wherein
the signal generating unit generates the signal instructing drag as well as a signal maintaining the drag, and after that, when it is determined that the touch position of the contact body is located inside the inside/outside determining target region and the touch state is cancelled before the touch position of the contact body moves to the outside of the inside/outside determining target region, cancels drag of the image object.

12. The image object control system according to claim 1, further comprising an inside/outside determining target region display unit for displaying the inside/outside determining target region so that the outer edge of the inside/outside determining target region can be visually recognized.

13. The image object control system according to claim 1, wherein the image object is a cursor.

14. An image object control method comprising steps of:
determining whether a touch position of a contact body is located outside or inside an inside/outside determining target region, the inside/outside determining target region being defined with respect to a display position of an image object as a target region for inside/outside determination of the touch position of the contact body; and
generating a signal indicating an operation performed with respect to the image object when it is determined that the touch position of the contact body is located outside the inside/outside determining target region.

15. The image object control method according to claim 14, further comprising a step of generating a signal instructing to move the image object as the signal indicating the operation performed with respect to the image object when it is determined that the touch position of the contact body is located outside the inside/outside determining target region.

16. A computer-readable storage medium recording an image object control program therein, the image object control program under which a computer executes inside/outside determining processing of determining whether a touch position of a contact body is located outside or inside an inside/outside determining target region, the inside/outside determining target region being defined with respect to a display position of an image object as a target region for inside/outside determination of the touch position of the contact body; and
signal generating processing of generating a signal indicating an operation performed with respect to the image object when it is determined that the touch position of the contact body is located outside the inside/outside determining target region.

17. The computer-readable storage medium recording the image object control program therein, the image object control program under which the computer generates a signal instructing to move the image object as the signal indicating the operation performed with respect to the image object when it is determined that the touch position of the contact body is located outside the inside/outside determining target region.

18. An image object control system comprising:
inside/outside determining means for determining whether a touch position of a contact body is located outside or inside an inside/outside determining target region, the inside/outside determining target region being defined with respect to a display position of an image object as a target region for inside/outside determination of the touch position of the contact body; and
a signal generating means for generating a signal indicating an operation performed with respect to the image object when it is determined that the touch position of the contact body is located outside the inside/outside determining target region.
